(19) United States
(12) Patent Application Publication
(10) Pub. No.: US 2012/0136673 A1
(43) Pub. Date: May 31, 2012

(54) METHODS, APPARATUSES AND COMPUTER PROGRAM PRODUCTS FOR DETERMINING CHANGES IN LEVELS OF CARE FOR PATIENTS

(75) Inventors: Ann Presley, Knoxville, TN (US); Jennifer C. Ginsberg, Denver, CO (US); Weichang Zhang, Greenwood Village, CO (US); Ian Owens, Arvada, CO (US); Mattew Woodberry Mitchell, Aurora, CO (US)

(73) Assignee: MCKESSON FINANCIAL HOLDINGS LIMITED

(21) Appl. No.: 12/956,313

(22) Filed: Nov. 30, 2010

(51) Int. Cl. G06Q 50/00; G06Q 10/00

(52) U.S. Cl. 705/2

(57) ABSTRACT

An apparatus is provided for determining a change in a level of care for a patient(s). The apparatus includes at least one memory and at least one processor configured to determine that at least one of an admission of a patient to a health care facility, a discharge of the patient from the health care facility, or a transfer of the patient within the health care facility triggered a level of care change event associated with the patient. The processor is also configured to identify a care event(s) for the patient in response to determining that the level of care change event was triggered. The processor is also configured to generate a notification(s) to perform a task(s) associated with the care event(s) for the patient and associate the care event(s) and a task(s) with the triggered level of care change event. Corresponding computer program products and methods are also provided.

### TECHNOLOGICAL FIELD

Embodiments of the invention relate generally to a mechanism of determining changes in levels of care for one or more patients, and more particularly relate to a method, apparatus and computer program product for generating one or more notifications identifying one or more care events that may need to be performed for patients based on identified changes in levels of care.

### BACKGROUND

Currently, health care facilities may track changes in levels of care of patients in order to provide proper medical care to patients and to ensure compliance with The Joint Commission's National Patient Safety Goals. The level of care changes may, for example, be associated with admission, discharge and transfer (ADT) events associated with patients. For instance, level of care changes may occur when a patient is admitted to a health care facility, transferred to another location or unit within the health care facility or discharged from the health care facility. One reason for tracking changes in a patient's level of care is that one or more health care activities for the patient may change when the patient's level of care changes. For example, when a level of care is changed, health care facilities may need to reconcile medications taken by the patient in order to comply with The Joint Commission's National Patient Safety Goals and to confirm that the medications that a patient is presently taking are appropriate for a different level of care.

At present, ADT events may be utilized to indicate when a patient's physical location within a health care facility has changed, and health care facilities may use the information associated with these changes in location to signify a level of care change based on policies and procedures of the health care facilities. However, utilization of the ADT data indicating changes in location of a patient (e.g., transfers) may provide inaccurate data as to a change in the level of care of a patient. For example, a patient's location within a health care facility may be changed from one bed to another bed within the same health care unit. Based on this location change, the health care facility may currently designate this change as a change in a level care. However, in actuality, the changing of one bed to another bed within the same health care unit typically does not alone relate to a change in a level of care for a patient. As such, this approach may yield false results in identifying changes in levels of care.

Since the current approach may yield false results, a clinician may need to manually check to ensure that the change in location of the patient does not correspond to a true change in a level of care, even though such a change in location may be designated by the system of the health care facility as resulting in a change in a level of care.

A drawback to the approach of indicating that changes in location of a patient within a health care facility automatically relates to changes in a level of care is, therefore, that it requires a clinician to manually determine whether the designated change in level of care is legitimate. However, manually determining whether a change in level of care is legitimate takes time and resources, and may be burdensome for clinicians.

In view of the foregoing drawbacks, it may be beneficial to provide an efficient and reliable mechanism of enabling health care clinicians to determine when a level of care has changed for a patient(s) within a health care facility so that optimal health care may be provided to patients based on one or more identified changes in levels of care.

### BRIEF SUMMARY

A method, apparatus and computer program product are therefore provided that may enable the provision of an efficient and reliable mechanism for determining one or more changes in levels of care for one or more patients within a health care facility. The exemplary embodiments may also trigger generation of one or more notifications informing one or more health care professionals that one or more care events may need to be performed for corresponding patients in response to determining a change in a level of care of the patients. The exemplary embodiments may also streamline one or more tasks associated with care events that may need to be performed on behalf of patients, which may result in quality improvements. Additionally, the exemplary embodiments may associate the care events with the change in the level of care which may support reporting and analysis for quality improvements.

A care event may be any medical task or activity performed in association with a patient. For example, the care events may include, but are not limited to, one or more medication reconciliations, consideration of acuity levels of one or more patients, consideration of dietary requirements of one or more patients, or any other suitable care events. The care events may be associated with changes in levels of care for corresponding patients. In this regard, the exemplary embodiments may determine that a corresponding care event(s) may be needed for a patient in response to determining that a level of care for a patient is changed.

Additionally, the exemplary embodiments may detect completion of the care events. In an example embodiment, detection of completion of care events may trigger the generation of one or more notifications informing health care professionals that the care events are completed.

In one exemplary embodiment, a method for determining a change in a level of care for one or more patients is provided. The method may include determining that at least one of an admission of a patient to a health care facility, a discharge of the patient from the health care facility, or a transfer of the patient within the health care facility triggered a level of care change event associated with the patient. The method may further include identifying at least one care event for the patient in response to determining that the level of care change event associated with the patient was triggered and generating one or more notifications to perform one or more tasks associated with the care event for the patient. The method may further include associating the care event and the one or more tasks with the triggered level of care change event.

In another exemplary embodiment, an apparatus for determining a change in a level of care for one or more patients is provided. The apparatus may include a memory and a processor configured to cause the apparatus to determine that at least one of an admission of a patient to a health care facility, a discharge of the patient from the health care facility, or a transfer of the patient within the health care facility triggered a level of care change event associated with the patient. The processor is further configured to cause the apparatus to identify at least one care event for the patient in response to determining that the level of care change event associated with the patient was triggered and generate one or more notifications to perform one or more tasks associated with the care event for the patient. The processor is further configured to associate the care event and the one or more tasks with the triggered level of care change event.

In another exemplary embodiment, a computer program product for determining a change in a level of care for one or more patients is provided. The computer program product includes at least one computer-readable storage medium having computer-executable program code instructions stored therein. The computer-executable program code instructions may include program code instructions configured to determine that at least one of an admission of a patient to a health care facility, a discharge of the patient from the health care facility, or a transfer of the patient within the health care facility triggered a level of care change event associated with the patient. The computer program product may further include program code instructions configured to identify at least one care event for the patient in response to determining that the level of care change event associated with the patient was triggered and generate one or more notifications to perform one or more tasks associated with the care event for the patient. The computer program product may further include program code instructions configured to associate the care event and the one or more tasks with the triggered level of care change event.

Embodiments of the invention may provide a method, apparatus and computer program product for enabling an efficient and reliable manner in which to determine instances in which a level of care of one or more patients is changed and for triggering generation of notifications informing health care professionals of one or more care events that may need to be performed for patients based on the changes in the level of care. As a result, communication device users may enjoy an improved experience in determining when a level of care is changed for one or more patients and for determining the care events and tasks that may be needed to ensure optimal care for patients based on changes in a level of care.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of communication device according to an exemplary embodiment of the invention;

FIG. 3 is a schematic block diagram of a computing device according to an exemplary embodiment of the invention;

FIG. 4 is a diagram of a user interface for enabling display of an indication of a care event associated with a patient being admitted to a health care entity according to an exemplary embodiment;

FIG. 5 is a diagram of user interfaces for enabling display of allergy information associated with a patient according to an exemplary embodiment;

FIG. 6 is a diagram of user interfaces for enabling display of home medications being taken by a patient according to an exemplary embodiment;

FIG. 7 is a diagram of user interfaces for enabling generation of a notification of a type of medication reconciliation according to an exemplary embodiment;

FIG. 8 is a diagram of user interfaces for enabling display of a notification that a medication reconciliation of a particular type may be needed according to an exemplary embodiment;

FIG. 9 is a diagram of user interfaces for changing a status of a needed notification of a medication reconciliation according to an exemplary embodiment;

FIG. 10 is a diagram of a user interface for generating a draft medication reconciliation according to an exemplary embodiment;

FIG. 11 is a diagram of user interfaces for indicating that a draft medication reconciliation is saved according to an exemplary embodiment;

FIG. 12 is a diagram of a user interface for enabling completion of the draft medication reconciliation according to an exemplary embodiment;

FIG. 13 is a diagram of user interfaces for enabling provision of an indication of a completed medication reconciliation according to an exemplary embodiment; and

FIG. 14 is a flowchart of an exemplary method for determining a change in a level of care and for triggering generation of an indication to perform one or more care events according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, “medication reconciliation” may refer to a comparison of one or more medications that a patient(s) may be prescribed to take, advised to take or otherwise takes according to one level of care versus one or more medications that the patient(s) should take on the basis of a change in a level of care.

### General System Architecture

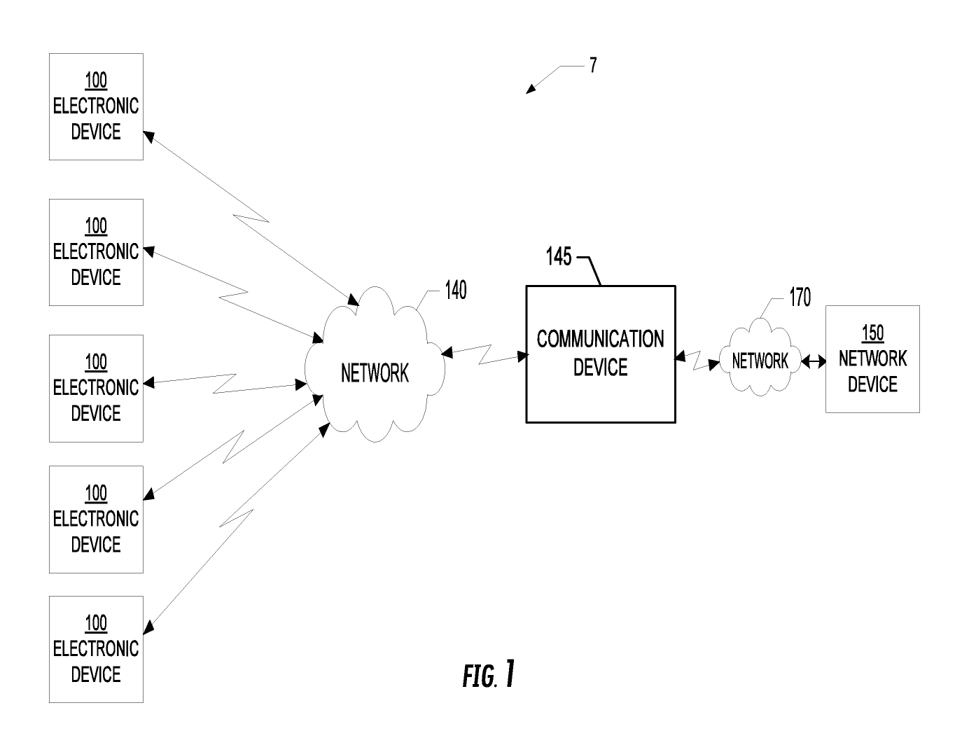

Reference is now made to FIG. 1, which is a block diagram of a system according to exemplary embodiments. The system may be maintained by a health care facility (e.g., hospital, clinic, etc.) As shown in FIG. 1, the system 7 may include one or more electronic devices 100 (e.g., personal computers, laptops, workstations, personal digital assistants, smart devices and the like, etc.) which may access one or more network entities such as, for example, a communication device 145 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 145 is capable of receiving data from and transmitting data to the electronic devices 100 via network 140. In one exemplary embodiment, the electronic devices 100 may be utilized by clinicians, pharmacists, physicians, physical therapists and/or any other suitable health care professionals.

Similarly, the communication device 145 may communicate with a network entity such as, for example, a network device 150 (e.g., server) or any other suitable network entity via network 170. In this regard, the communication device 145 may receive data from and transmit data to the network device 150. The network 170 may be a wired or wireless local area network (LAN), a metropolitan network (MAN) and/or a wide area network (WAN) (e.g., the Internet). The network device 150 may provide the communication device 145 with data indicating, for example, instances in which one or more patients are; (a) admitted to a health care facility; (b) transferred to one or more locations or units within a health care facility; and/or (c) discharged from a health care facility. In this regard, in one example embodiment, the network device 150 may be a registration device that tracks the status of one or more patients from a time in which the patients may be admitted to the health care facility of the system 7 to a time in which the patients may be discharged from the health care facility of the system 7.

It should be pointed out that although FIG. 1 shows five electronic devices 100, one communication device 145 and one network device 150, any suitable number of electronic devices 100, communication devices 145 and network devices 150 may be part of the system of FIG. 1 without departing from the spirit and scope of the invention.

### Communication Device

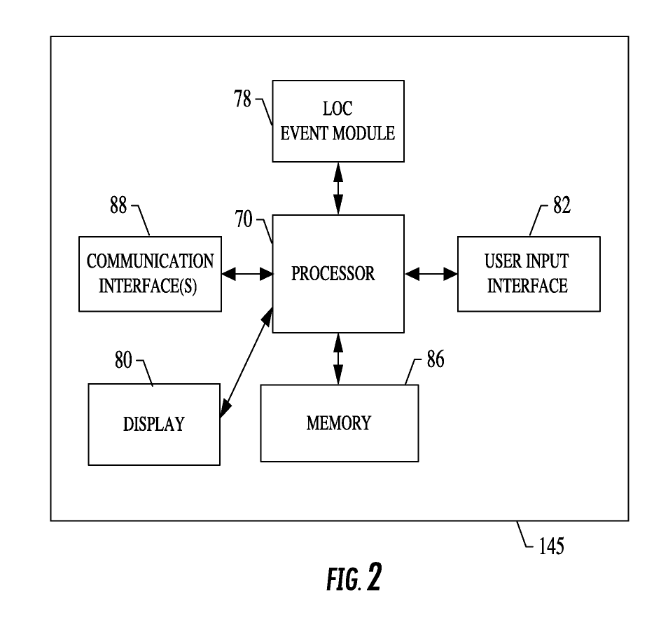

FIG. 2 illustrates a block diagram of a communication device according to an exemplary embodiment of the invention. The communication device 145 may, but need not, be a network entity such as for example, a server. The communication device 145 includes various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 145 may include a processor 70 connected to a memory 86. The memory may comprise volatile and/or non-volatile memory, and typically stores content (e.g., media content), data, information or the like.

For example, the memory may store content transmitted from, and/or received by, the electronic devices 100 and/or network device 150. In an exemplary embodiment, the memory 86 may store data associated with one or more values (e.g., numbers (e.g., 5, 10, 15, 20, 25, etc.)) that may be assigned as weightings to one or more locations or units within a health care facility for determining changes in one or more levels of care. Additionally, data may be included in the memory 86 specifying that a change in a level of care occurs when a patient is to be transferred from one location or unit assigned a value that is different from a value corresponding to the location or unit to which the patient is being transferred. In an exemplary embodiment, locations may include, but are not limited to, rooms, beds, bed levels, floors, and any other suitable locations within a health care facility. In addition, units may include, but are not limited to, one or more departments (e.g., intensive care units (ICUs), emergency rooms (ERs), medical surgery floors, etc) within a health care facility. The memory 86 may also include data specifying that an admission of a patient to a health care facility and/or a discharge of a patient to a health care facility relates to a change in a level of care.

Also for example, the memory 86 typically stores client applications, instructions, algorithms or the like for execution by the processor 70 to perform steps associated with operation of the communication device in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, electronic devices 100, and/or network device 150 over one or more networks (e.g., network 140, network 170) such as a Local Area Network (LAN), wireless LAN (WLAN), Wide Area Network (WAN), Wireless Wide Area Network (WWAN), the Internet, or the like. Alternatively, the communication interface can support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a level of care (LOC) event module 78. The LOC event module 78 may be any means such as a device or circuitry operating in accordance with software or otherwise embodied in hardware or a combination of hardware and software thereby configuring the device or circuitry (e.g., a processor or controller) to perform the corresponding functions of the LOC event module 78, as described below. In examples in which software is employed, a device or circuitry (e.g., processor 70 in one example) executing the software forms the structure associated with such means. As such, for example, the LOC event module 78 may be configured to, among other things, determine one or more changes in levels of care and trigger generation of notifications signifying that one or more health care events may need to be performed for corresponding patients based on a detection of a change in a level of care, as described more fully below.

It should be pointed out that the LOC event module 78 may examine data in memory 86 to determine whether a level of care is changed. For instance, the LOC event module 78 may analyze data in memory 86 and may determine that a level of care is changed in an instance in which a patient is admitted to a health care facility or discharged from the health care facility. Additionally, the LOC event module 78 may analyze data in memory 86 associated with weighting values assigned to one or more units or locations within a health care facility. In this regard, the LOC event module 78 may determine that a level of care is changed in an instance in which the LOC event module 78 determines that a value assigned to a current location or unit (e.g., a value of 5 assigned to an emergency room) of a patient within a health care facility is different from a value assigned to a location or unit (e.g., a value of 10 assigned to an intensive care unit) to which the patient is being transferred in the heath care facility.

On the other hand, the LOC event module 78 may determine that a level of care remains unchanged in an instance in which the LOC event module 78 determines that a value assigned to a current location or unit of a patient within a health care facility is the same as a value assigned to a location or unit to which the patient is being transferred in the heath care facility.

### Computing Device

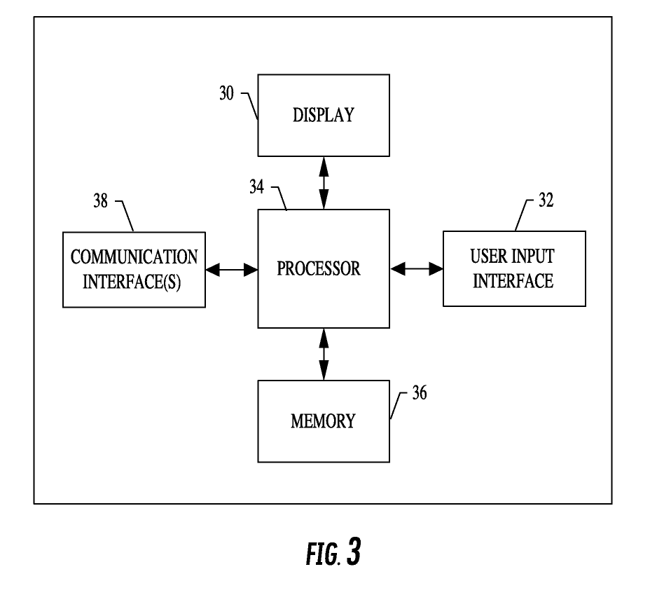

Referring now to FIG. 3, a block diagram of a computing device according to an exemplary embodiment is provided. The computing device is capable of operating as network device 150 or any of electronic devices 100. In this regard, the network device 150 and electronic devices 100 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. Additionally, the memory device 36 may store client applications, software (e.g., software code) algorithms, instructions or the like for the processor 34 to perform steps associated with operation of the computing device.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display, or any other input device.

### Exemplary System Operation

Exemplary embodiments of the invention may provide an efficient and reliable mechanism for determining a change in a level of care and for triggering generation of one or more notifications informing one or more health care professionals that a care event(s) is to be performed for a corresponding patient(s) in response to determining that a level of care of the patient changed. Additionally, the exemplary embodiments may detect completion of the health care event(s), which may trigger the exemplary embodiments to generate one or more notifications informing the health care professionals that the care event(s) is completed.

In this regard, the exemplary embodiments may facilitate detection of an admission, discharge or transfer (ADT) event associated with one or more patients. For example, the communication device 145 may receive data from a device such as, for example, network device 150 indicating an instance in which a patient is admitted to a health care facility (e.g., hospital), discharged from the health care facility or transferred to a different location or unit within the health care facility. The LOC event module 78 may analyze data in memory 86 to determine whether the admission, discharge or transfer of the patient within units or locations of the health care facility relate to a change in a level of care.

In an example embodiment, the data in the memory (e.g., memory 86) that may be analyzed by the LOC event module 78 may specify that an admission of a patient or a discharge of a patient relates to a change in a level of care. Additionally, the data in the memory that may be analyzed by the LOC event module 78 may specify that a change in a level of care occurs in an instance in which a value assigned to one location or unit (e.g., a value of 10 for a rehabilitation unit) from which a patient is being transferred is different from a value assigned to a location or unit (e.g., a value of 15 for a medical surgical unit) to which the patient is to be transferred.

Determination, by the LOC event module 78, that an ADT event results in a change in a level of care may trigger the LOC event module 78 to generate one or more notifications that one or more care events associated with a patient(s) should be performed. In an example embodiment, a care event is any medical task or activity to be performed in association with a patient. These may include, but are not limited to, performing one or more medication reconciliations, performing one or more tasks associated with acuity levels of a patient, performing one or more tasks associated with dietary considerations of a patient and any other suitable care events. The notifications may be provided to devices (e.g., electronic devices 100) of one or more members of the health care team by the LOC event module 78. The members of the health care team may include, but are not limited to, one or more nurses, physicians, pharmacists, physical therapists, etc. that may be designated as providing health care services to a patient(s). Additionally or alternatively, the LOC event module 78 may enable the notifications to be accessible (e.g., via a website, a portal, a user interface(s), etc.) by one or more devices of the members of a health care team. The notifications generated by the LOC event module 78 may notify corresponding members of the health care team to perform one or more tasks associated with one or more care events (e.g., a medication reconciliation).

Detection, by the LOC event module 78, that the tasks associated with one or more care events are completed may trigger the LOC event module 78 to generate one or more notifications indicating that the care events are completed (e.g., one or more notifications that a medication reconciliation is completed). The notifications indicating that the care events are completed may be provided to devices (e.g., electronic devices 100) of one or more members of the health team by the LOC event module 78. Additionally or alternatively, the LOC event module 78 may enable the notifications to be accessible (e.g., via a website, a portal, a user interface(s), etc.) by one or more devices (e.g., electronic devices 100) of the members of the health care team. In this regard, the members of the health care team may know that the care events are completed.

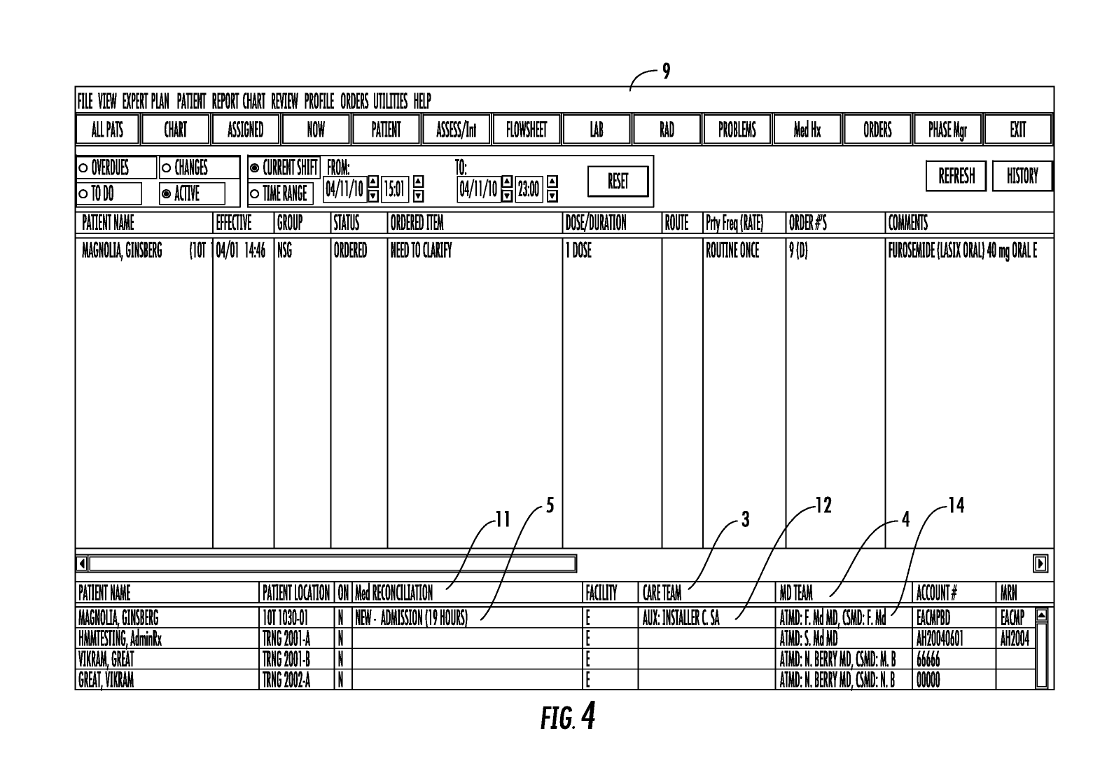

As an example in which the LOC event module 78 may determine whether an ADT event relates to a change in a level of care, which may trigger the LOC event module 78 to generate one or more notifications corresponding to a care event(s), consider FIGS. 4-14 described more fully below for purposes of illustration and not of limitation.

Referring now to FIG. 4, an exemplary embodiment of a diagram of a user interface indicating detection of an ADT event associated with a patient is provided. The LOC event module 78 may generate the user interface 9 of FIG. 4, in response to the communication device 145 receiving an indication from the network device 150 that a patient is being admitted to a health care facility (e.g., hospital). In response to determining that a patient is being newly admitted to the health care facility, the LOC event module 78 may evaluate data in the memory 86 to determine whether a level of care has changed with respect to the patient. In this exemplary embodiment, the LOC event module 78 may determine that data stored in the memory 86 specifies that admission of a patient to a health care facility signifies a change in a level of care. As such, the LOC event module 78 may determine that the admission of patient Ginsberg Magnolia to a health care facility relates to a change in a level of care. In an alternative exemplary embodiment, in an instance in which the LOC event module 78 determined that the patient was being discharged from the health care facility, the LOC event module 78 may analyze data in the memory 86 specifying that the discharge corresponds to a change in a level of care. In another alternative exemplary embodiment, in an instance in which the patient is already admitted to the health care facility and is being transferred from one location or unit to another location or unit within the health care facility, the LOC event module may analyze data in the memory 86. By analyzing the data in the memory 86 the LOC event module 78 may determine that a level of care changes with respect to the patient based on the current location or unit from which the patient is being transferred having a value that is different from a value assigned to the location or unit to which the patient is being transferred.

In another alternative exemplary embodiment, a health care professional may utilize a user input interface (e.g., user input interface 32) of a device such as, for example, an electronic device 100 to manually designate an event as corresponding to a change in a level of care, even in an instance in which the LOC event module 78 may not automatically determine that an event corresponds to a change in a level of care. For instance, if a patient is in a surgical room having surgery performed and is moved to another surgical room to have another surgery performed, the LOC event module 78 may not determine that a level of care changed because the values associated with the surgical rooms may be the same. As such, since the health care professional may know that the move of the patient from one surgical room to another surgical room may result in a change in a level of care, the health care professional may utilize a user interface generated by the LOC event module 78 to manually designate the event as a change in a level of care.

Determination of the change in level of care by the LOC event module 78, either automatically or based on manual input from a health care professional, may trigger the LOC event module 78 to generate an indication that one or more events (also referred to herein as care events) should be performed for the patient. For instance, in the example embodiment of FIG. 4, in response to determining that the admission of patient Ginsberg Magnolia relates to a change in level of care, the LOC event module 78 may generate an indication 11 that an event such as, for example, a medical reconciliation should be completed for patient Ginsberg Magnolia.

Additionally, the LOC event module 78 may generate visible indicia 5 indicating that the patient is newly admitted to the health care facility. The visible indicia 5 may also indicate that the amount of time (e.g., 19 hours) that the patient has been admitted without receiving a specific care event from one or more health care professionals such as, for example, a nurse of a care team 12 and/or a physician of a team of a medical doctors 14 (also referred to herein as MD team 14). The LOC event module 78 may also generate visible indicia 3 indicating a care team (e.g., also referred to herein as health care team) that may perform one or more medical tasks/activities on behalf of patient Ginsberg Magnolia. In an example embodiment, the care team may include, but is not limited to, one or more nurses, pharmacists, physical therapists and any other suitable health care professional(s). It should be pointed out that each member of the health care team may be able to access the user interface 9 via an electronic device 100. The LOC event module 78 may also generate visible indicia 4 indicating a team of one or more medical doctors (also referred to herein as MD team 4). For instance, one team of medical doctors may provide medical care to patient Magnolia Ginsberg denoted by visible indicia 14, in the example of FIG. 4.

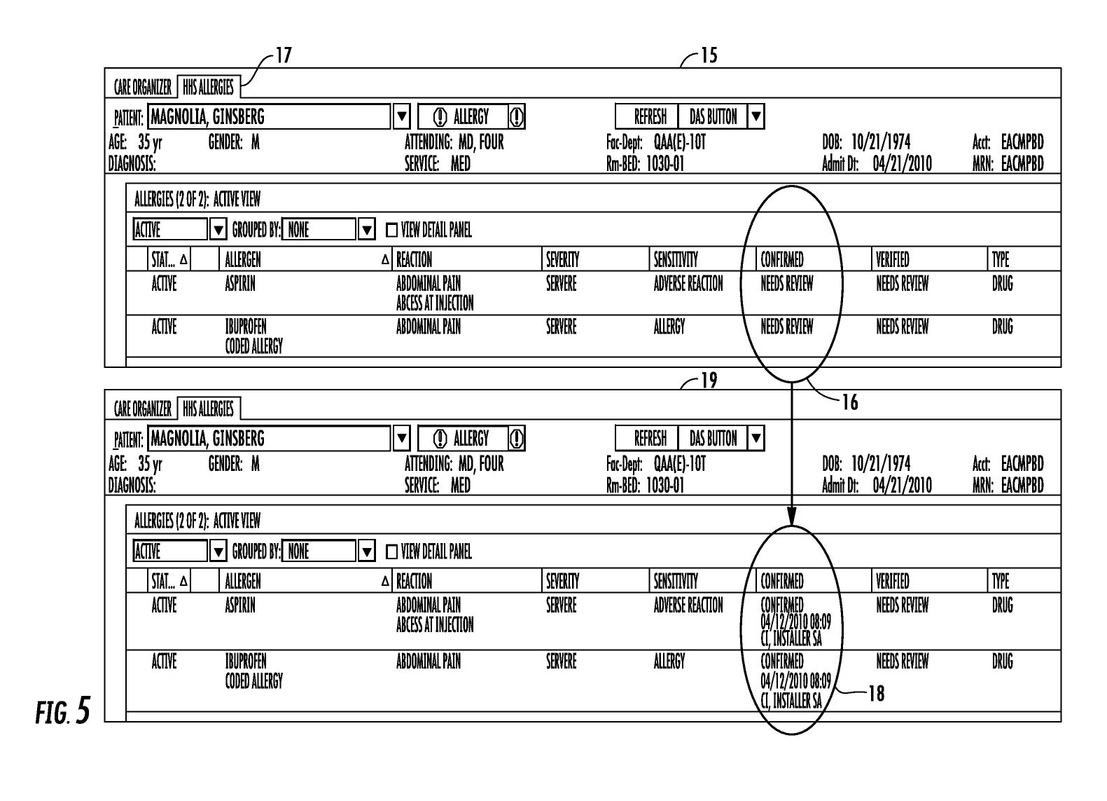

Referring now to FIG. 5, a diagram of user interfaces for enabling display of one or more identified allergies of a patient is provided. The user interface 15 may be generated by the LOC event module 78 in response to receipt of a selection of a menu, button, tab 17 (also referred to herein as HHS Allergies tab 17), or the like. In an example embodiment, a health care professional such as, for example, a nurse may utilize the user input interface 32 of an electronic device 100 to indicate the allergies of patient Ginsberg Magnolia, which may be shown by the user interface 15. In an alternative exemplary embodiment, in an instance in which the LOC event module 78 determines that the allergies for Ginsberg Magnolia were previously saved in a memory such as, for example, memory 86, the LOC event module 78 may automatically generate visible indicia indicating the allergies of patient Ginsberg Magnolia, via user interface 15. In the example embodiment of FIG. 5, a health care professional (e.g., a nurse) providing care services for patient Ginsberg Magnolia may need to confirm 16 that the information indicating the allergies is correct. In response to the health care professional confirming that the information indicating the allergies is correct, the LOC event module 78 may generate the user interface 19 and may generate visible indicia 18 denoting that the information indicating the allergies of patient Ginsberg Magnolia is confirmed.

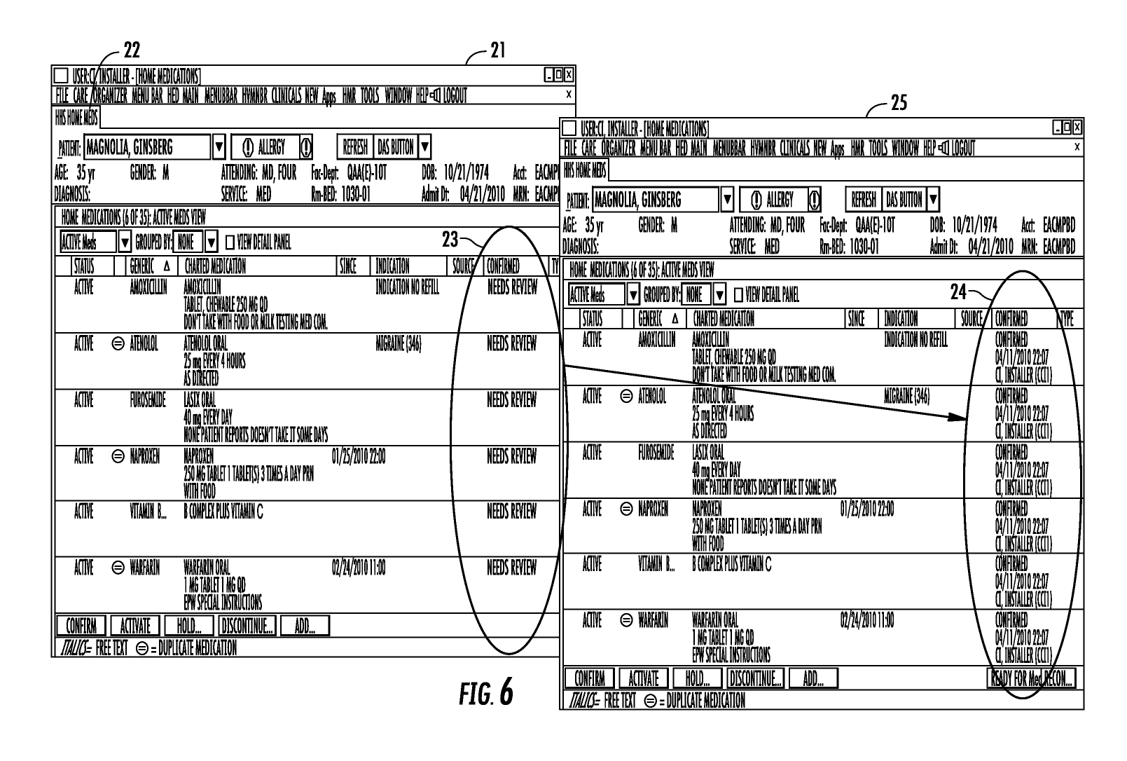

Referring now to FIG. 6, an exemplary embodiment of user interfaces for enabling display of visible indicia denoting one or more home medications of a patient are provided. In the example embodiment of FIG. 6, the LOC event module 78 may generate the user interface 21 in response to receipt of a selection of a tab 22 (also referred to herein as HHS Home Meds tab 22). A health care professional (e.g., nurse) of a care team may utilize a user input interface 32 of an electronic device 100 that may access the user interface 21 to input data indicating one or more home medications being taken by patient Ginsberg Magnolia prior to being admitted to the health care facility. The health care professional may obtain the information indicating the home medications from patient Ginsberg Magnolia, in this example.

Alternatively, the LOC event module 78 may automatically determine the home medications being taken by patient Ginsberg Magnolia based on data stored in a memory such as, for example, memory 86. For instance, data indicating the home medications being taken by patient Ginsberg Magnolia may be stored in memory 86 based on data obtained from one or more previous prescriptions generated by a physician(s) of the health care facility. The LOC event module 78 may enable display of the home medications being taken by Ginsberg Magnolia via the user interface 21.

Additionally, the LOC event module 78 may generate visible indicia 23 denoting that the home medications need to be confirmed. Once a health care professional (e.g., nurse) confirms that the home medications are correct, the LOC event module 78 may generate user interface 25. As shown on FIG. 6, user interface 25 may include visible indicia 24 denoting that the home medications were confirmed. In one embodiment, the health care professional may confirm the home medications by asking the patient to verify that the home medications identified by the health care professional are correct.

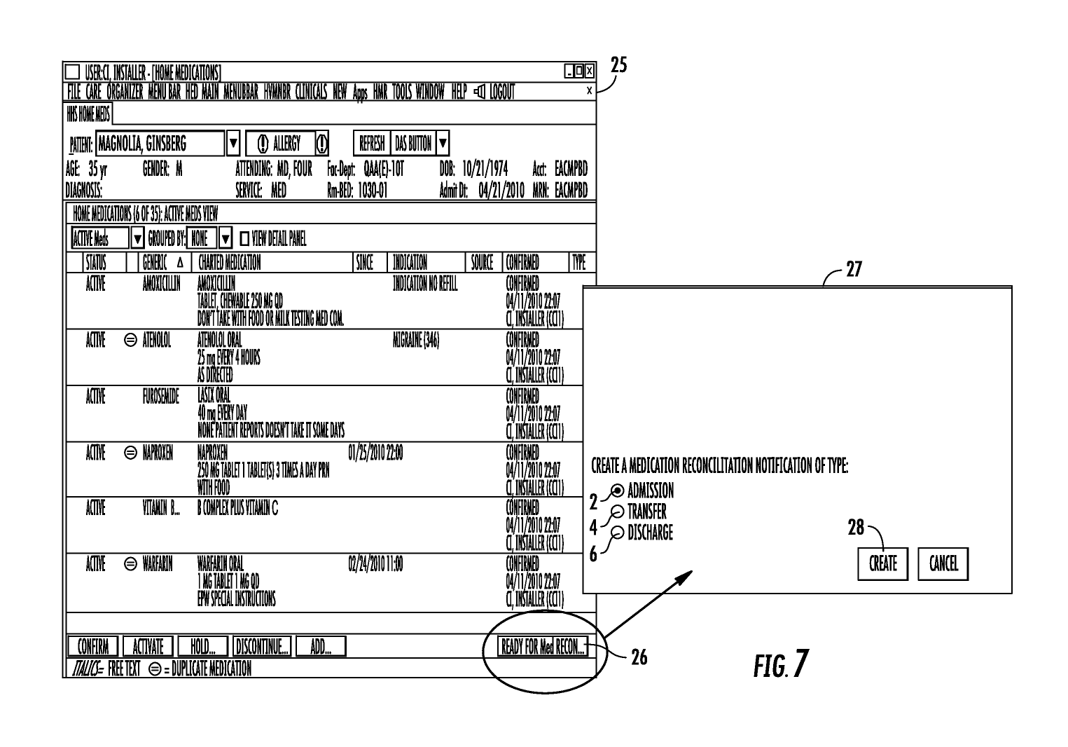

Referring now to FIG. 7, an exemplary embodiment of a user interface for indicating that a medication reconciliation is needed is provided. In the example of FIG. 7, the LOC event module 78 may generate the user interface 27 in response to receipt of a selection of a tab 26 or the like of user interface 25. Selection of the tab 26 may also indicate to the LOC event module 78 that a health care professional (e.g., a nurse) or the like completed a collection of home medications for a patient (e.g., Ginsberg Magnolia). In this regard, the LOC event module 78 may generate user interface 27 indicating that a medication reconciliation notification relating to an admission should be generated. In response to receipt of a selection of admission radio button 2 and the tab 28, the LOC event module 78 may generate a medication reconciliation notification. In this example embodiment, the medication reconciliation notification may have a type associated with an admission to a health care facility. In an alternative exemplary embodiment, a medication reconciliation notification may have a type associated with a transfer of a patient from one location or unit to another location or unit within a health care facility or a type based on a discharge of a patient from a health care facility. In this regard, in an instance in which the LOC event module 78 determined that the level of care corresponds to a transfer of a patient from one location or unit to another location or unit, the health care professional may select the transfer radio button 4 and the tab 28 to trigger the LOC event module 78 to generate a transfer medication reconciliation notification.

In another alternative exemplary embodiment, in an instance in which the LOC event module 78 determined that the level of care corresponds to a pending discharge of a patient from a health care facility, the health care professional may select the discharge radio button 6 and the tab 28 to trigger the LOC event module 78 to generate a discharge medication reconciliation notification.

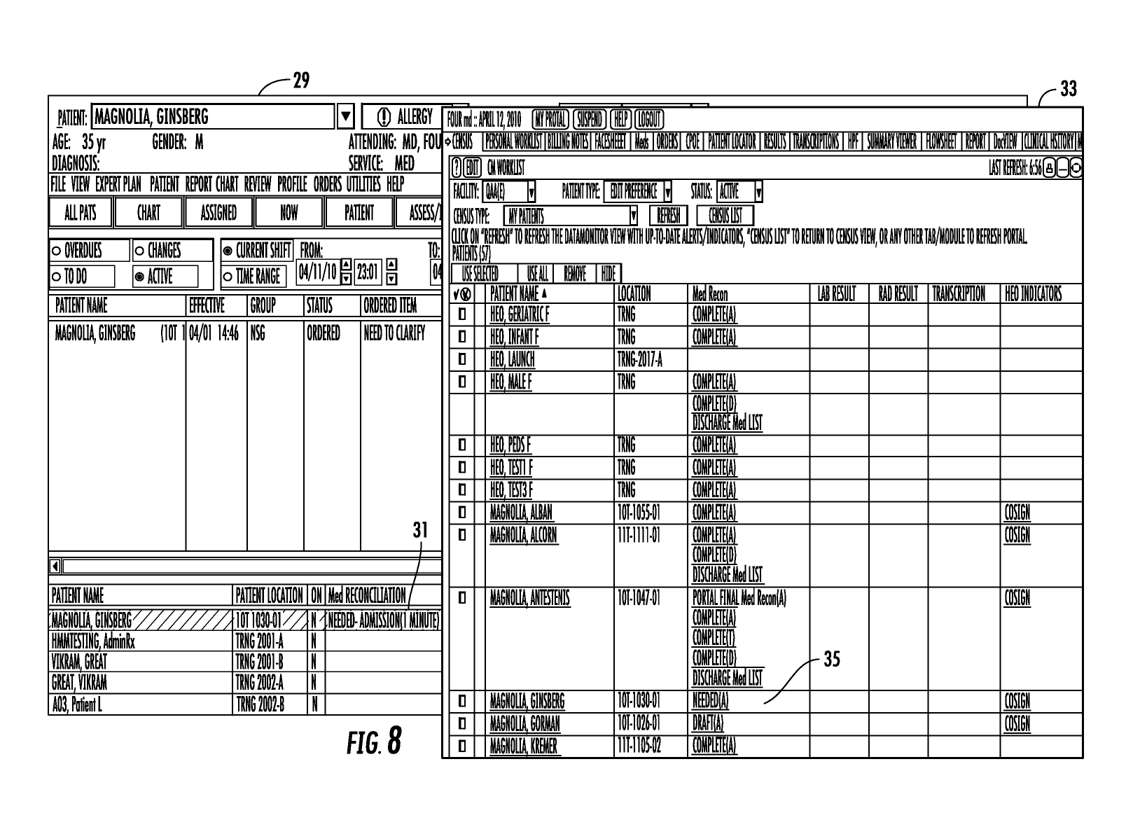

Referring now to FIG. 8, an exemplary embodiment of user interfaces indicating that a medication reconciliation is needed is provided. In this example embodiment, receipt of a selection of the tab 28 of the user interface 27 of FIG. 7 may trigger the LOC event module 78 to generate user interface 29 and may enable display of visible indicia 31 indicating a medication reconciliation is needed of the admission type for a patient such as, for example, Ginsberg Magnolia. In the example embodiment of FIG. 8, the user interface 29 may be accessible by one or more health care professionals (e.g., a nurse) of the care team associated with visible indicia 12 via a device such as, for example, electronic device 100. In an alternative exemplary embodiment, in an instance in which a detected change in a level of care relates to a transfer of a patient from one location to another location of the health care facility, the LOC event module 78 may enable the user interface 29 to indicate that a medication reconciliation of the transfer type is needed. In another alternatively exemplary embodiment, in an instance in which a detected change in a level of care relates to a pending discharge of a patient from the health care facility, the LOC event module 78 may enable the user interface 29 to indicate that a medication reconciliation of the discharge type is needed.

Additionally or alternatively, receipt of the selection of the tab 28 of the user interface 27 of FIG. 7 may trigger the LOC event module 78 to generate user interface 33 and may enable display of viable indicia 35 indicating that a medication reconciliation of the admission type is needed for a patient such as, for example, Ginsberg Magnolia. The user interface 31 may be accessible by one or more physicians of the MD team associated with visible indicia 14 via a device, such as for example, electronic device 100.

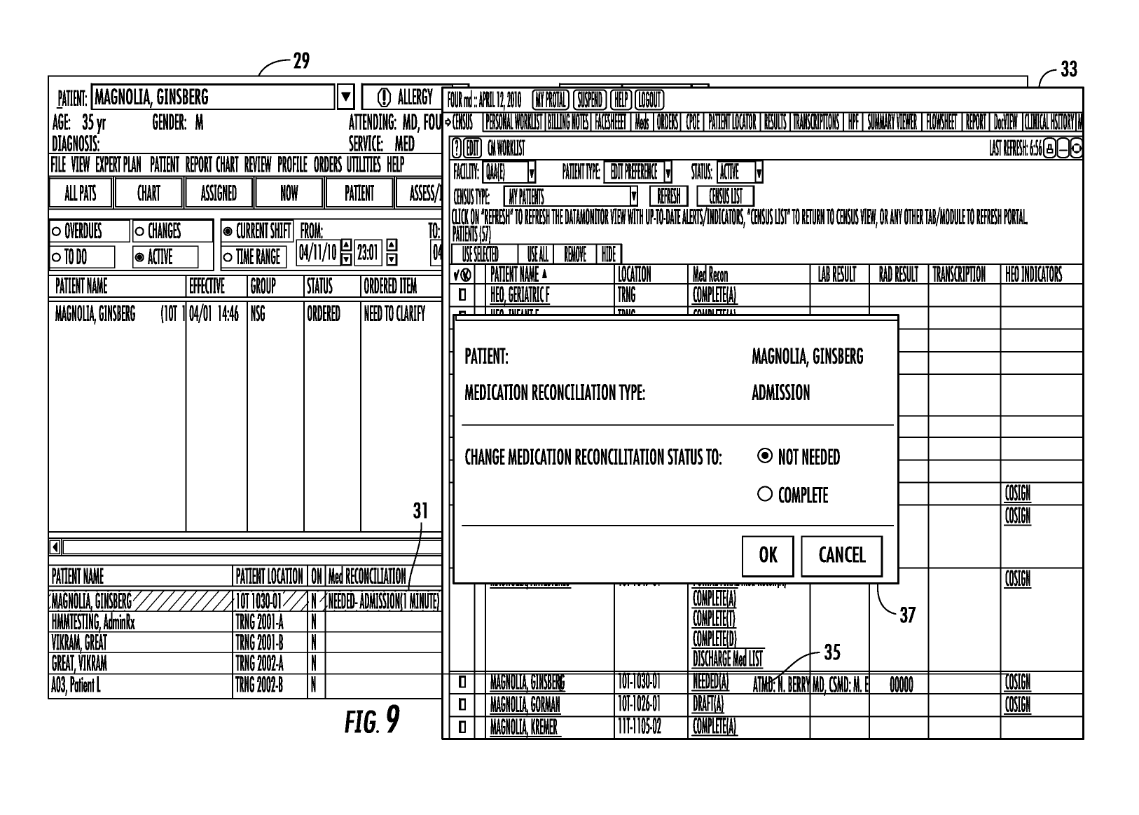

Referring now to FIG. 9, an exemplary embodiment of user interfaces for changing a status of a medication reconciliation is provided. In the example embodiment of FIG. 9, the LOC event module 78 may generate a user interface 37 which may enable a status of a needed medication reconciliation to be changed. For instance, a status of a needed medication reconciliation notification may be changed to not needed for any suitable reason(s) including but not limited to a determination that the medication reconciliation notification was generated in error, cancellation of an admission of a patient, etc. Additionally, a status of a needed medication reconciliation may be changed via user interface 37 to complete. As an example, a status of a needed medication reconciliation may be changed to complete via user interface 37 in an instance in which a medication reconciliation was generated and completed in a non-electronic manner such as, for example, completion of the medication reconciliation on paper, or for any other suitable reasons.

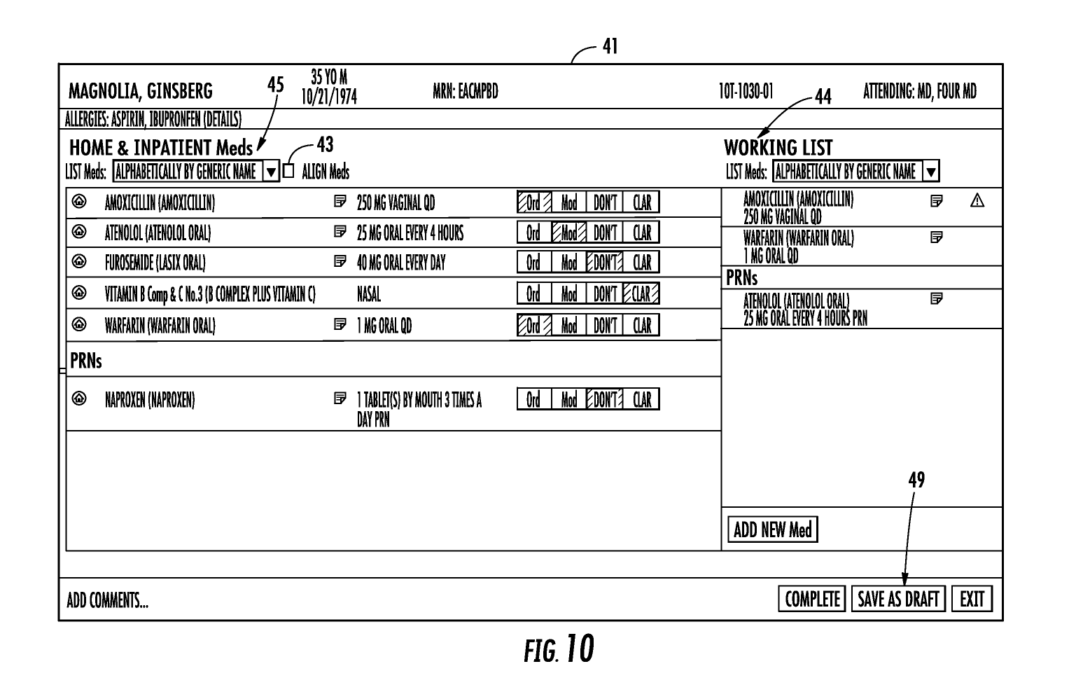

Referring now to FIG. 10, an exemplary embodiment of a user interface for generating a draft of a medication reconciliation is provided. The LOC event module 78 may generate the user interface 41 in response to determining that a medication reconciliation is needed. In response receipt of a selection of a button such as the align meds button 43, the LOC event module 78 may generate visible indicia enabling a health care professional (e.g., a physician) or the like to reconcile one or more medications for a patient (e.g., Ginsberg Magnolia). As shown in FIG. 10, the user interface 41, generated by the LOC event module 78, may include one or more home and inpatient medications 45 of a patient that may be reconciled by a health care professional (e.g., a physician) based on a determination as to whether the medications are applicable for another (e.g., changed) level of care.

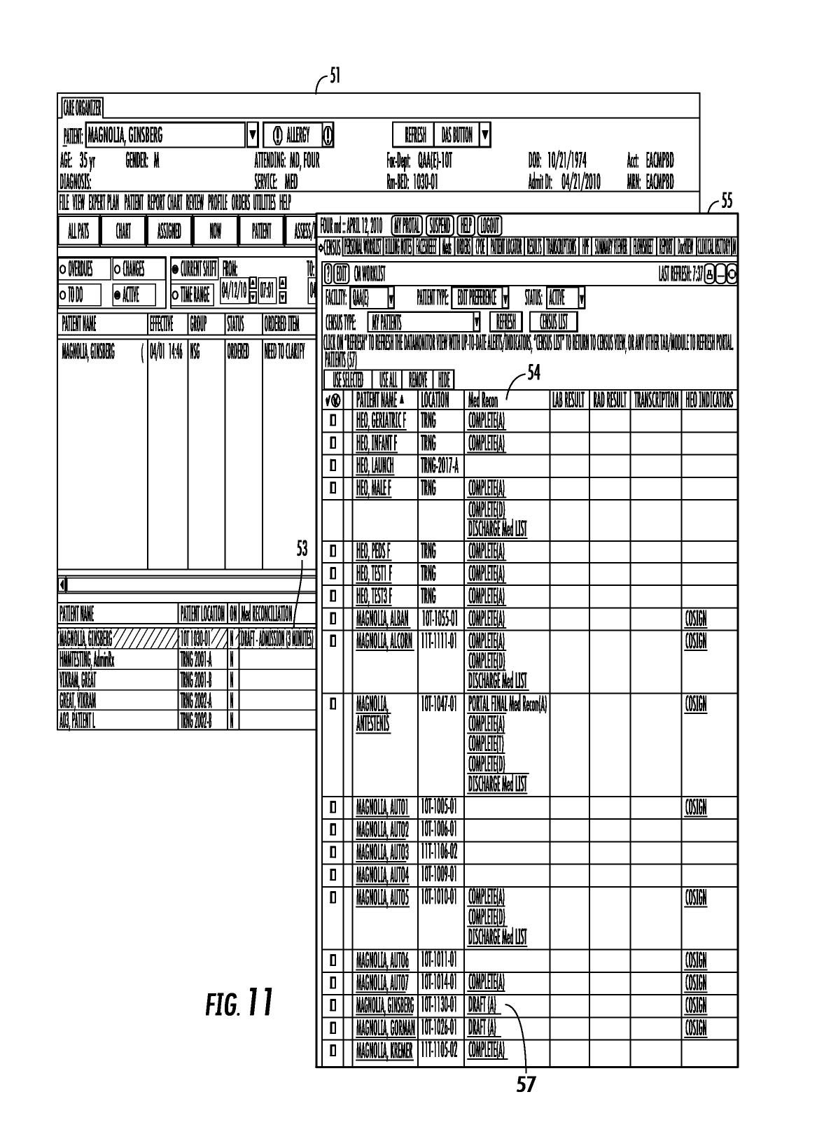

In this regard, for example, the health care professional may determine that amoxicillin should be ordered (Ord), that Atenolol should be modified (Mod), that Furosemide should not be ordered or prescribed (Don't). The physician may also determine that clarification (Clar) is needed regarding Vitamin B Comp & C No. 3, that Warfarin needs to be ordered (Ord) and that Naproxen should not be ordered or prescribed (Don't). At least some of the medication reconciliations may be visible in the working list 44 of the user interface 41. In the example embodiment of FIG. 11, the health care professional may be unable to complete the medication reconciliation at a particular time and in this regard the health care professional may save a draft of the medication reconciliation. As an example, the health care professional may be unable to complete the medication reconciliation at the particular time because of an emergency or for any other suitable reason. In this regard, the LOC event module 78 may save a draft of the incomplete medication reconciliation in response to receipt of a selection of the tab 49.

Referring now to FIG. 11, an exemplary embodiment of user interfaces are provided for enabling display of a notification of a draft medication reconciliation. The LOC event module 78 may generate the user interfaces 51 and 55 enabling display of the notification of the draft medication reconciliation generated in the example embodiment of FIG. 10 in response to receipt of an indication of a selection of tab 49. In this regard, the LOC event module 78 may generate visible indicia 53 indicating the notification of the draft medication reconciliation of the admission type via user interface 51. The user interface 53 may be accessible by one or more health professionals of the care team associated with the visible indicia 12, via a device such as, for example, an electronic device 100.

Additionally or alternatively, the LOC event module 78 may generate visible indicia 57 indicating a notification of the draft medication reconciliation via user interface 55. The visible indicia 57 denoting the notification of draft medication reconciliation of the admission type may be associated with the medication reconciliation (Med Recon) 54 column of the user interface 55. The Med Recon 54 column may be associated with one or more statuses of a plurality of medication reconciliation notifications, generated by the LOC event module 78, which may be associated with corresponding patients within a health care facility. The user interface 55 may be accessible by one or more physicians of the MD team associated with the visible indicia 14, via a device such as, for example, an electronic device 100.

It should be pointed out that a level of care may change corresponding to a patient (e.g., patient Ginsberg Magnolia) during a time period in which the notification of the draft medication reconciliation is pending. For instance, a location of a patient location may change within a health care facility during a time period in which the notification of the draft medication reconciliation is pending. In an instance in which the LOC event module 78 detects a level of care change while the notification of the draft medication reconciliation is pending, the LOC event module 78 may generate a notification indicating that a new medication reconciliation is needed based on a transfer due to a change in the patient's location and a determination that the transfer relates to a change in a level of care.

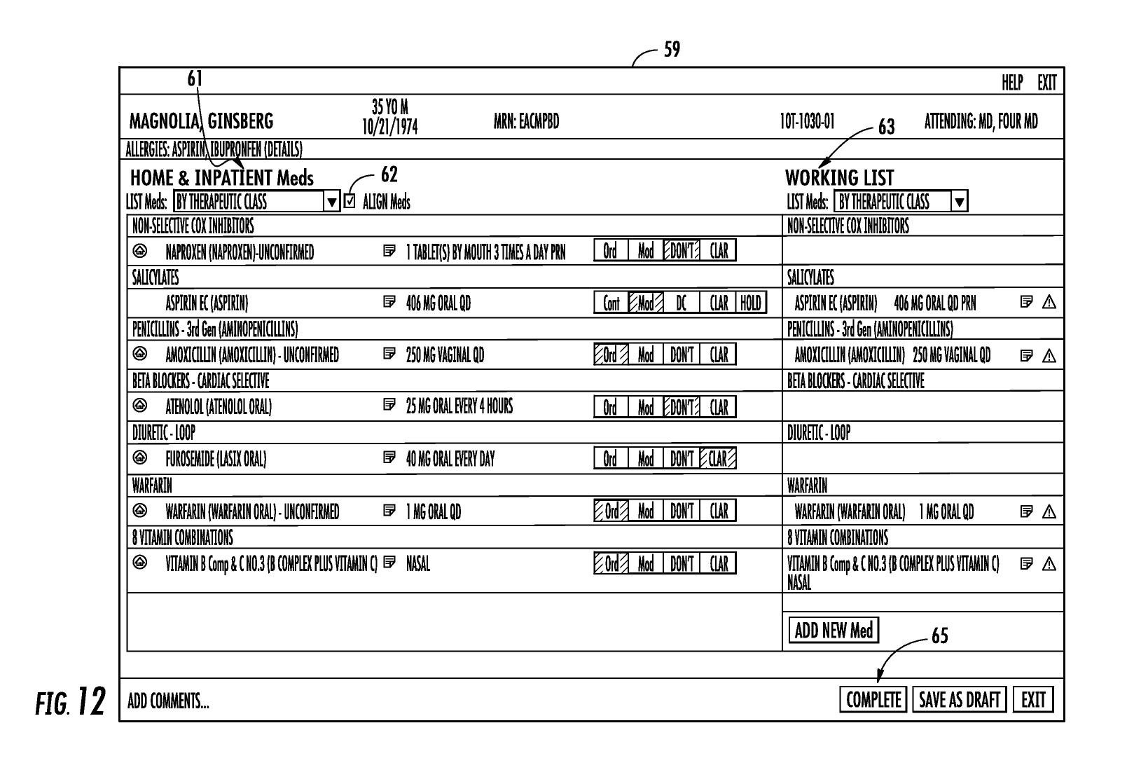

Referring now to FIG. 12, an exemplary embodiment of a user interface is provided for enabling completion of a medication reconciliation. The LOC event module 78 may generate the user interface 59. In one example embodiment, the LOC event module 78 may generate the user interface 59 in response to receipt a selection of the visible indicia 57 corresponding to the draft medication reconciliation of the user interface 55 of FIG. 11. In the example embodiment of FIG. 12, a health care professional such as, for example, a physician may complete the draft medication reconciliation, in response to selecting the align meds button 62, by determining whether the home and inpatient medications 61 are appropriate for a changed level of care. The appropriate medications and their corresponding quantities/dosages for a corresponding level of care may be associated with a working list 63 upon being selected by the health care professional (e.g., a physician). In response to receipt of an indication of the selection of the tab 65, the LOC event module 78 may save a complete or finalized medication reconciliation associated with a patient (e.g., Ginsberg Magnolia).

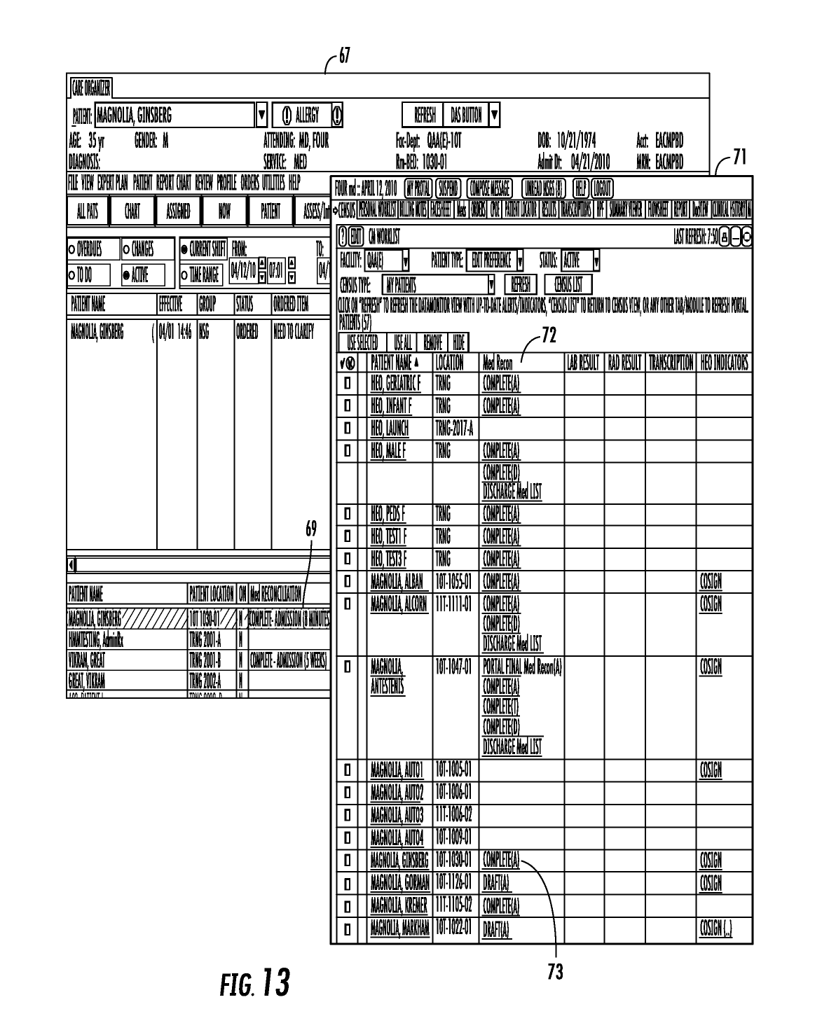

Referring now to FIG. 13, an exemplary embodiment of user interfaces indicating a notification of a completed medication reconciliation are provided. The LOC event module 78 may generate the user interface 67 and the user interface 71. In an example embodiment, the user interfaces 67 and 71 may be generated by the LOC event module 78 in response to detecting a selection of the tab 65 of user interface 59 of FIG. 12. In the example embodiment of FIG. 13, the LOC event module 78 may provide visible indicia 69 to the user interface 67 indicating a notification of a completion of the medication reconciliation of FIG. 12. The user interface 67 may be accessible by one or more health care professionals of the care team associated with visible indicia 12, via a device such as, for example, an electronic device 100.

Additionally or alternatively, the LOC event module 78 may generate the user interface 71 with visible indicia 73 indicating a notification of a completion of the medication reconciliation of FIG. 12. The visible indicia 73 corresponding to the notification of the completed medication reconciliation for a patient (e.g., Ginsberg Magnolia) may be associated with a medication reconciliation (Med Recon) 72 column. The Med Recon 72 column may be associated with one or more statuses of a plurality of medication reconciliations notifications corresponding to patients within a health care facility. In an exemplary embodiment, the user interface 71 may be accessible by one or more physicians of the MD team associated with visible indicia 14, via a device such as, for example, an electronic device 100.

In the example embodiment of FIG. 13, the completed medication reconciliation may relate to the admission type (e.g., data indicating “Complete (A)” associated with visible indicia 73). However, in an alternative exemplary embodiment, in an instance in which the level of care relates to a transfer of a patient, the LOC event module 78 may generate the user interface 67 and the user interface 71 with visible indicia denoting that the completed medication reconciliation is of a transfer type (e.g., data indicating “Complete (T)”). Additionally, in another alternative exemplary embodiment, in an instance in which the level of care relates to a discharge of a patient from a health care facility, the LOC event module 78 may generate the user interface 67 and the user interface 71 with visible indicia denoting that the completed medication reconciliation is of a discharge type (e.g., data indicating “Complete (D)”).

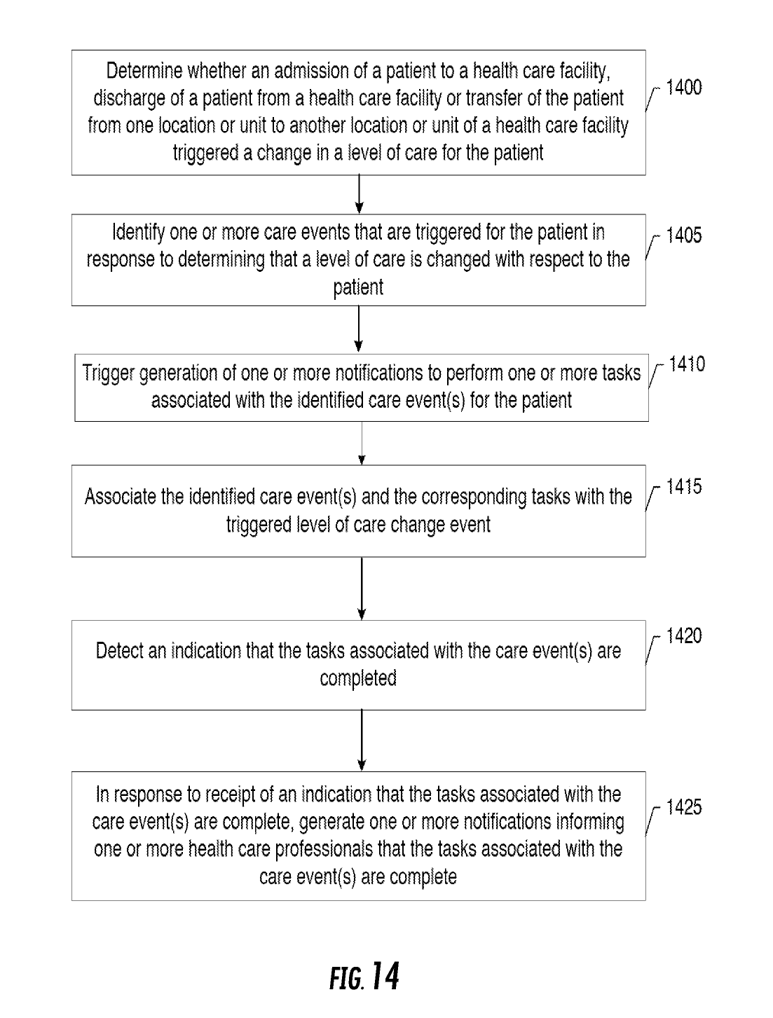

Referring now to FIG. 14, an exemplary method for determining a change in a level of care and for triggering generation of an indication to perform one or more care events is provided. At operation 1400, an apparatus (e.g., communication device 145) may determine whether an admission of a patient to a healthcare facility, a discharge of the patient from the health care facility or a transfer of the patient from one location or unit to another location or unit of a health care facility (e.g., ADT events) triggered a change in a level of care for the patient (e.g., a level of care change event). In one embodiment, for example, all admittances and discharges may trigger a level of care change event, whereas only transfers from a location or unit with one associated value to a location or unit with another associated value may result in a level of care change event.

At operation 1405, the apparatus may identify one or more care event(s) (e.g., medication reconciliation, acuity level consideration, dietary requirements consideration, etc.) that are triggered for the patient in response to determining that a level of care is changed with respect to the patient (e.g., in response to determining that a level of care change event was triggered). In one example embodiment, the care event triggered may depend upon the cause of the level of care change. For example, a care event triggered by a level of care change resulting from a patient being admitted may differ from a care event triggered by a level of care change resulting from a patient being either transferred or discharged. In another exemplary embodiment, the triggered care event may differ depending upon the value change between the location/unit from which the patient is transferred and the location/unit to which the patient is transferred. For example, a transfer from a location of value 5 to a location of value 10 may trigger one care event, while a transfer from a location of value 10 to a location of value 5 may trigger a different care event. As a result, in order to identify the care event(s) triggered, the apparatus may, in one example embodiment, identify (e.g., by accessing a database) the applicable care event(s) based on characteristics of the level of care change.

At operation 1410, the apparatus may trigger generation of one or more notifications to perform one or more tasks associated with the identified care event(s) for the patient. At operation 1415, the apparatus may associate the identified care event(s) and the corresponding tasks with the triggered level of care change event. In one embodiment, tying the assigned care event(s) and tasks with the level of care change event may enable completion of notifications (discussed below), as well as reporting and analysis for compliance and quality improvement.

At operation 1420, the apparatus may detect an indication that the tasks associated with the care event(s) are completed. At operation 1425, in response to receipt of an indication, by the apparatus, that the tasks associated with the care event(s) are completed, the apparatus may generate one or more notifications informing one or more health care professionals that the tasks associated with the care event(s) are complete.

It should be pointed out that FIG. 14 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86, memory 36) and executed by a processor (e.g., processor 70, processor 34, LOC event module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 14 above may comprise a processor (e.g., the processor 70, the processor 34, the LOC event module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 34, the processor 70 (e.g., as means for performing any of the operations described above), the LOC event module 78 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining that at least one of an admission of a patient to a health care facility, a discharge of the patient from the health care facility, or a transfer of the patient within the health care facility triggered a level of care change event associated with the patient;
identifying, via a processor, at least one care event for the patient in response to determining that the level of care change event associated with the patient was triggered;
generating one or more notifications to perform one or more tasks associated with the care event for the patient; and
associating the care event and the one or more tasks with the triggered level of care change event.

2. The method of claim 1, further comprising:
determining that the transfer of the patient triggered a level of care change event in response to determining that a value assigned to a first location within the health care facility from which the patient is transferred is different from a value assigned to a second location within the health care facility to which the patient is transferred.

3. The method of claim 1, further comprising:
receiving an indication that the tasks are completed; and
in response to receipt of an indication that the tasks are completed, generating one or more additional notifications informing one or more health care professionals that the tasks are complete.

4. The method of claim 1, wherein the care event comprises a medication reconciliation relating to a comparison of one or more medications of the patient taken according to a first level of care versus one or more medications that the patient is to take based on the level of care change event.

5. The method of claim 1, wherein identifying, via a processor, at least one care event for the patient in response to determining that the level of care change event associated with the patient was triggered, further comprises identifying at least one care event based at least in part on one or more characteristics of the triggered level of care change event.

6. The method of claim 1, further comprising:
determining that the transfer of the patient did not trigger a level of care change event in response to determining that a value assigned to a first location within the health care facility from which the patient is transferred is the same as a value assigned to a second location within the health care facility to which the patient is transferred.

7. The method of claim 1, wherein at least one of the notifications comprises an indication that a medication reconciliation is needed to be performed by at least one health care professional of a care team.

8. The method of claim 7, wherein the medication reconciliation is associated with one or more types of notifications and wherein the method further comprises:
determining the types of notifications based in part on whether the change in the level of care relates to a detection of the admission, the pending discharge or the transfer.

9. The method of claim 1, further comprising:
enabling the notifications to be accessible via one or more devices of health care professionals providing health care services to the patient; and
enabling provision of display of indications corresponding to statuses of a plurality of medication reconciliations associated with respective patients.

10. An apparatus comprising:
at least one memory; and
at least one processor configured to cause the apparatus to:
determine that at least one of an admission of a patient to a health care facility, a discharge of the patient from the health care facility, or a transfer of the patient within the health care facility triggered a level of care change event associated with the patient;
identify at least one care event for the patient in response to determining that the level of care change event associated with the patient was triggered;
generate one or more notifications to perform one or more tasks associated with the care event for the patient;
associate the care event and the one or more tasks with the triggered level of care change event.

11. The apparatus of claim 10, wherein the processor is further configured to cause the apparatus to:
determine that the transfer of the patient triggered a level of care change event in response to determining that a value assigned to a first location within the health care facility from which the patient is transferred is different from a value assigned to a second location within the health care facility to which the patient is transferred.

12. The apparatus of claim 10, wherein the processor is further configured to cause the apparatus to:
receive an indication that the tasks are completed; and
in response to receipt of an indication that the tasks are completed, generate one or more additional notifications informing one or more health care professionals that the tasks are complete.

13. The apparatus of claim 10, wherein the care event comprises a medication reconciliation relating to a comparison of one or more medications of the patient taken according to a first level of care versus one or more medications that the patient is to take based on the level of care change event.

14. The apparatus of claim 10, wherein the processor is further configured to cause the apparatus to identify at least one care event for the patient in response to determining that the level of care change event associated with the patient was triggered by identifying at least one care event based at least in part on one or more characteristics of the triggered level of care change event.

15. The apparatus of claim 10, wherein the processor is further configured to cause the apparatus to:
determine that the transfer of the patient did not trigger a level of care change event in response to determining that a value assigned to a first location within the health care facility from which the patient is transferred is the same as a value assigned to a second location within the health care facility to which the patient is transferred.

16. The apparatus of claim 10, wherein at least one of the notifications comprises an indication that a medication reconciliation is needed to be performed by at least one health care professional of a care team.

17. The apparatus of claim 16, wherein the medication reconciliation is associated with one or more types of notifications and wherein the processor is further configured to cause the apparatus to:
determine the types of notifications based in part on whether the change in the level of care relates to a detection of the admission, the pending discharge or the transfer.

18. The apparatus of claim 10, wherein the processor is further configured to cause the apparatus to:
enable the notifications to be accessible via one or more devices of health care professionals providing health care services to the patient; and
enable provision of display of indications corresponding to statuses of a plurality of medication reconciliations associated with respective patients.

19. A computer program product comprising at least one computer-readable storage medium having computer-executable program code instructions stored therein, the computer executable program code instructions comprising:
program code instructions configured to determine that at least one of an admission of a patient to a health care facility, a discharge of the patient from the health care facility, or a transfer of the patient within the health care facility triggered a level of care change event associated with the patient;
program code instructions configured to identify at least one care event for the patient in response to determining that the level of care change event associated with the patient was triggered;
program code instructions configured to generate one or more notifications to perform one or more tasks associated with the care event for the patient and program code instructions configured to associate the care event and the one or more tasks with the triggered level of care change event.

20. The computer program product of claim 19, further comprising:
program code instructions configured to determine that the transfer of the patient triggered a level of care change event in response to determining that a value assigned to a first location within the health care facility from which the patient is transferred is different from a value assigned to a second location within the health care facility to which the patient is transferred.
